(19) United States
(12) Patent Application Publication
(10) Pub. No.: US 2013/0174567 A1
(43) Pub. Date: Jul. 11, 2013

(54) Automatic Engine Noise Reduction

(71) Applicants: Stacey H. Light, San Diego, CA (US); James C. Napier, San Diego, CA (US)

(72) Inventors: Stacey H. Light, San Diego, CA (US); James C. Napier, San Diego, CA (US)

(73) Assignee: HAMILTON SUNDSTRAND CORPORATION, Windsor Locks, CT (US)

(21) Appl. No.: 13/347,147

(22) Filed: Jan. 10, 2012

(51) Int. Cl. F02C 9/00

(52) U.S. Cl. 60/773; 60/39.24

(57) ABSTRACT

A method of reducing engine noise for an engine under little or low load conditions includes the steps of: establishing an engine idle speed for the engine when the engine has less than a predetermined minimum level of load; measuring the level of load on the engine; measuring the speed of the engine; and reducing the speed of the engine to the engine idle speed if the measured level of load on the engine is less than the predetermined minimum level of load and the measured speed of the engine is greater than the engine idle speed.

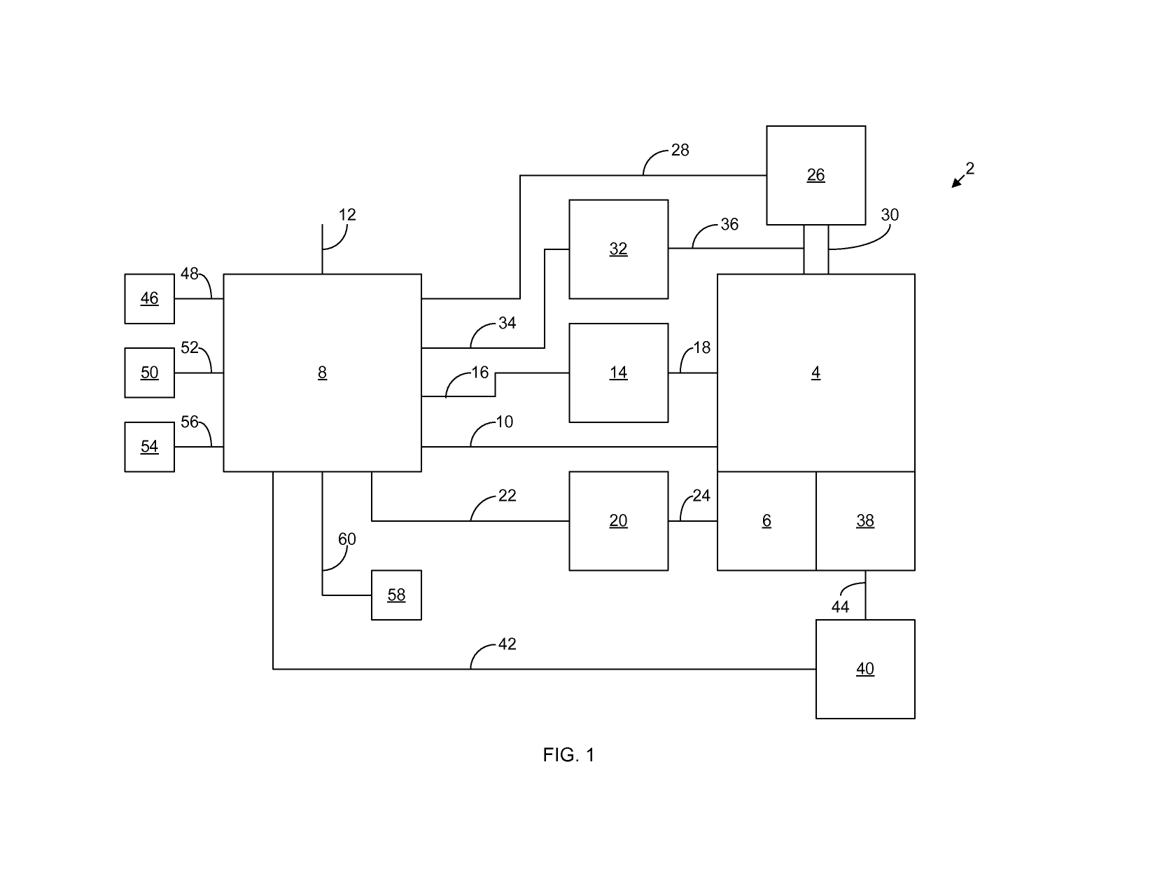

FIG. 1 is a schematic diagram of an engine system according to a possible embodiment.

Referring to FIG. 1, an engine system 2 according to a possible embodiment comprises a gas turbine engine 4 with a compressor 6 and an engine controller 8. The engine controller 8 controls the speed of the gas turbine engine 4 by way of an engine controller output signal on an engine controller output line 10. The engine controller 8 may be of a full authority digital engine control (FADEC) type that is responsive to signals such as a throttle signal on a throttle command line 12.

The engine controller 8 establishes an idle speed for the gas turbine engine 4, which engine idle speed is sufficient to permit a predetermined minimum level of load on the gas turbine engine 4 whilst maintaining engine noise at a level that is lower than the level of noise that the gas turbine engine 4 generates within its normal range of operating speeds above the idle speed. The engine controller 8 may measure the load on the gas turbine engine 4 by various means. For instance, the engine controller 8 may receive a signal representative of measured level of engine load from an exhaust gas temperature (EGT) sensor 14 by way of an EGT sensor output line 16, which EGT sensor 14 senses the EGT of the gas turbine engine 4 by way of a temperature sensing path 18.

The engine controller 8 may receive a signal representative of measured level of engine load from an air flow sensor 20 by way of an air flow sensor output line 22, which air flow sensor 20 senses the level of consumed bleed air from the engine compressor 6 by way of a bleed air flow path 24. The engine controller 8 may receive a signal representative of measured level of engine load from an engine load sensor 26 by way of an engine load sensor output line 28, which engine load sensor 26 senses the level of shaft load by way of an engine output shaft 30.

The engine controller 8 may receive a signal representative of measure level of engine speed by way of an engine speed detection system. The engine speed detection system may comprise an engine speed sensor 32 that produces the signal representative of measured level of engine speed on an engine speed sensor output line 34, which engine speed sensor 32 senses the engine speed by way of a mechanical coupling path 36 to the engine output shaft 30. If the gas turbine engine 4 has an alternating current (AC) electric generator 38, the engine speed detection system may otherwise comprise a frequency to speed converter system 40 that produces the signal representative of measured level of engine speed by way of a frequency to speed converter output line 42, which frequency to speed converter system 40 detects the frequency of power that the AC electric generator 38 generates on an AC electric generator power output line 44.

The engine controller 8 may also receive loading information from a variety of loading information signals. For instance, an environmental control system (ECS) 46 that utilises compressed air generated by the compressor 6 may provide an ECS loading signal to the engine controller 8 on an ECS loading signal line 48. An electrical power distribution system (PDS) 50 that utilises electrical power generated by the generator 38 may provide a PDS loading signal to the engine controller on a PDS loading signal line 52. The engine controller 8 may additionally receive a control system load demand signal from a control system 54 on a control system load demand signal line 56, which may represent specific load demands such as engine start.

The engine controller 8 may also utilise various internally generated control parameters to determine loading conditions for the gas turbine engine 4. For instance, the engine controller 8 may generate a fuel control signal received by an engine fuel system 58 on a fuel control signal line 60 to maintain operating speed of the gas turbine engine 4.

The engine controller 8 compares the engine load as indicated by the signal representative of measured level of engine load with the predetermined minimum level of load. The engine controller 8 also compares the engine speed as indicated by the signal representative of measure level of engine speed with the engine idle speed. If the engine load is less than the predetermined minimum level of load and the engine speed is greater than the engine idle speed, the engine controller 8 will send an engine controller output signal to the gas turbine engine 4 by way of the engine controller output line 10 that reduces the speed of the gas turbine engine 4 to the engine idle speed. If the engine controller 8 determines that the engine load as indicated by the signal the signal representative of measured level of engine load is greater than the predetermined minimum level of load, the engine controller 8 will send an engine controller output signal to the gas turbine engine 4 by way of the engine controller output line 10 that maintains or increases the speed of the gas turbine engine 4 above the engine idle speed.

The described embodiments as set forth herein represent only some illustrative implementations of the invention as set forth in the attached claims. Changes and substitutions of various details and arrangement thereof are within the scope of the claimed invention.

1. A method of reducing engine noise for an engine under little or low load conditions, comprising the steps of:
establishing an engine idle speed for the engine when the engine has less than a predetermined minimum level of load;
measuring the level of load on the engine;
measuring the speed of the engine; and
reducing the speed of the engine to the engine idle speed if the measured level of load on the engine is less than the predetermined minimum level of load and the measured speed of the engine is greater than the engine idle speed.

2. The method of claim 1, wherein the step of establishing an engine idle speed for the engine when the engine has less than a predetermined level of load comprises selecting the engine idle speed to be a level that is sufficient to drive the measured level of load and to reduce engine noise to a level that is lower than the level of noise that the engine generates within its normal range of operating speeds above the idle speed.

3. The method of claim 1, wherein the step of measuring the level of load on the engine comprises the steps of:
measuring exhaust gas temperature (EGT) of the engine; and
correlating the measured EGT with a calculated engine load corresponding to the measured EGT.

4. The method of claim 1, wherein the step of measuring the level of load on the engine comprises the steps of:
measuring a level of consumed bleed air discharged by a compressor for the engine; and
correlating the measured level of consumed bleed air with a calculated engine load corresponding to the measured level of bleed air.

5. The method of claim 1, wherein the step of measuring the level of load on the engine comprises measuring a level of shaft load on the engine.

6. The method of claim 1, wherein the step of reducing the speed of the engine comprises comparing the measured engine speed to the engine idle speed.

7. The method of claim 1, further comprising the step of increasing the speed of the engine above the engine idle speed if the measured level of load on the engine exceeds the predetermined minimum level of load.

8. An engine system that reduces engine noise under little or low load conditions, comprising:
an engine with a compressor; and
an engine controller that controls the speed of the engine, the engine controller responsive to signals representative of measured level of engine load and measured level of speed of the engine such that it reduces the speed of the engine to an engine idle speed if the measured level of load on the engine is less than a predetermined minimum level of load and the measured speed of the engine is greater than the engine idle speed.

9. The engine system of claim 8, wherein the engine controller sets the engine idle speed to a level that is sufficient to drive the predetermined level of load and to reduce engine noise to a level that is lower than the level of noise that the gas turbine engine 4 generates within its normal range of operating speeds above the idle speed.

10. The engine system of claim 8, further comprising an exhaust gas temperature (EGT) sensor that measures a level of EGT of the engine and produces the signal representative of measured level of engine load.

11. The engine system of claim 8, further comprising an air flow sensor that measures a level of consumed bleed air from the engine compressor and produces the signal representative of measured level of engine load.

12. The engine system of claim 8, further comprising an engine load sensor that measures a level of shaft load on the engine and produces the signal representative of measured level of engine load.

13. The engine system of claim 8, wherein the engine controller compares the measured engine speed with the engine idle speed.

14. The engine system of claim 8, wherein the engine controller increases the speed of the engine above the engine idle speed if the measured level of load on the engine exceeds the predetermined minimum level of load.

15. The engine system of claim 8, further comprising an engine speed detection system that produces the signal representative of measured level of speed of the engine.

16. The engine system of claim 8, wherein the engine speed detection system comprises an engine speed sensor that produces the signal representative of measured level of speed of the engine.

17. The engine system of claim 15, wherein the engine has an alternating current (AC) electric generator and the engine speed detection system comprises a frequency to speed converter system that detects the frequency of power that the AC electric generator generates and produces a signal representative of measured level of speed of the engine.

18. An engine system that reduces engine noise under little or low load conditions, comprising:
a gas turbine engine with a compressor;
a sensor that produces a signal representative of engine load;
an engine speed detection system that produces a signal representative of engine speed; and
an engine controller that controls the speed of the engine, the engine controller responsive to the signal representative of measured level of engine load and the signal representative of measured level of speed of the engine such that it reduces the speed of the engine to an engine idle speed if the measured level of load on the engine is less than a predetermined minimum level of load and the measured speed of the engine is greater than the engine idle speed.

19. The engine system of claim 18, wherein the sensor that produces a signal representative of engine load comprises an exhaust gas temperature (EGT) sensor that measures EGT of the engine and produces the signal representative of measured level of engine load.

20. The engine system of claim 18, wherein the sensor that produces a signal representative of engine load comprises an air flow sensor that measures a level of consumed bleed air from the engine compressor and produces the signal representative of measured level of engine load.

21. The engine system of claim 18, wherein the sensor that produces a signal representative of engine load comprises an engine load sensor that measures a level of shaft load on the engine and produces the signal representative of measured level of engine load.

22. The engine system of claim 18, wherein the engine speed detection system that produces a signal representative of engine speed comprises an engine speed sensor that produces the signal representative of measured level of speed of the engine.

23. The engine system of claim 18, wherein the engine has an alternating current (AC) electric generator and the engine speed detection system comprises a frequency to speed converter system that detects the frequency of power that the AC electric generator generates and produces a signal representative of measured level of speed of the engine.
